(19) United States
(12) Patent Application Publication
(10) Pub. No.: US 2012/0307254 A1
(43) Pub. Date: Dec. 6, 2012

(54) Modal-domain optical fiber sensor system

(75) Inventors: Robert Globus, Portland, OR (US); Charles Osborne, Portland, OR (US); Peter Lovely, Portland, OR (US)

(73) Assignee: PICOKINETIX LLC, Portland, OR (US)

(21) Appl. No.: 13/134,329

(22) Filed: Jun. 6, 2011

(51) Int. Cl. G01B 9/02

(52) U.S. Cl. 356/477

(57) ABSTRACT

A modal-domain optical fiber sensor device having the sensing fiber constructed of multimode optical fiber, reflectively terminated on one end, the non-terminated end receiving coherent light and outputting speckle pattern light that is geometrically filtered by at least one detection fibers' diameter, angular position, or physical location in relation to the sensing fiber's non-terminated end. The coherent light is directed from a coherent source to the sensing fiber's non-terminated end by at least one injection optical fiber that is oriented side by side with the detection fibers, and secured within a launch optical coupler (LOC). The LOC secures the non-terminated end of the sensing in light communication with the detection optical fibers and injection optical fibers.

### FIELD OF INVENTION

The present invention relates to optical fiber sensors, generally, and to modal domain multimode optical fiber sensors for vibration monitoring and as mechanical motion detectors, in particular.

### BACKGROUND OF THE INVENTION

Optical or light based sensor devices have historically been used in science and industry, and with recent technological advances that have decreased the cost of lasers and fiber- optic equipment, fiber-optic sensors are now becoming commonplace in commercial and industrial environments. Fiber-based sensors are not disrupted by electromagnetic interference (EMI, also called radio frequency interference or RFI) and do not produce the same. Light sensing or ‘listening’ is the preferred method in many applications.

Understanding how to listen or sense with light using an optical fiber requires a fundamental knowledge of how discrete propagation modes in optical fibers change when impacted by disturbance, and how the changes may be sensed or detected. There are single-mode interferometric sensors and multimode interferometric sensors that rely upon “speckle pattern” shifts to sense disturbances in the optical fiber. The sensing type and method referenced herein and as utilized by the applicant's invention is the second sensing type: multimode fiber output, “speckle pattern” shift sensing, commonly referred to as modal-domain sensing.

The speckle or interference pattern emerging from an optical fiber varies in shape and intensity, and shifts or moves when the fiber-optic waveguide is disturbed. Vibrations or physical changes in the fiber-optic waveguide cause small fractional shifts in the light distribution within the waveguide and these speckle-pattern variations can be observed at the end of the fiber. Sensing the shifting speckle or multi-path interference pattern is the mechanism for listening or sensing with light described herein.

For modal interference to occur there must be a coherent light source, typically a semiconductor laser, which is used to inject the optical fiber with light. LED technology does not lend itself to this type of application to date as LEDs have broad incoherent optical spectra that do not produce profound multipath interference effects or a high contrast speckle pattern.

A simple photodetector that is spatially or angularly limited to receive only part of the optical beam which exits a fiber enables shifts or vibrations of the speckle pattern to be discerned. This form of geometric restriction (either spatially or angularly) is critical, otherwise the detected power would be constant and shifts in the speckle pattern would not be discernable.

In the prior art by Lovely in U.S. Pat. No. 5,144,689, a multimode fiber sensor system has a photodetector on one end of the sensing fiber, with the laser injecting coherent light into the opposing end of the sensing fiber. The system as claimed by Lovely includes a laser for injecting light into a first end of the sensing fiber, a sensing fiber for projecting a speckle pattern out its second end, a detection fiber for collecting a portion of the speckle pattern light at the second end of the sensing fiber and providing output signal to a detection means, the detection means for measuring the intensity of said output. As the laser is injecting on one end of the sensing fiber, and the detection means is receiving at the second end of the sensing fiber, electronics and hardware are necessary at each end of the sensing fiber, which in many applications is not desirable. Further, only one input into the photo detector makes the Lovely sensor subject to speckle pattern fading, which decreases sensitivity, especially impacting the sensor's ability to determine changes in amplitude.

To help further illustrate, a single photodetector modal-domain optical fiber sensor system configuration as shown in U.S. Pat. No. 6,937,151 (Tapanes) is another good example. The sensor configuration described is a fiber-based sensor coupled to a perimeter (ie: a fence). The sensor is an optical waveguide such as a single or multimode optical fiber and has a coherent light source launched into one end and a spatial filter with photodetector on the other end to receive or “view” the output. When disturbances at the perimeter occur, the optical fiber waveguide is impacted by the disturbance and changes the phase of the discrete propagation modes within the optical fiber, causing interference pattern shifts that are detected at the photodetector, thereby sensing the disturbance.

In one embodiment, Tapanes teaches that the laser light injected or launched into one end of a multimode sensing fiber from a single-mode optical fiber is sufficient in generating a plurality of modes within the multimode sensing fiber and when used with a spatial filter or restriction device at the far end of the sensing fiber and monitored with a photodetector, produces a varying current in a photodetector that is correlated with the magnitude and frequency of the fiber perturbation or disturbance. This is the most commonly configured form of a modal-domain or speckle sensor and is well established in the prior art.

In another embodiment form, Tapannes requires complex integration of single-mode, pigtailed components; specifically: a laser source, detector, coupler and a spatial or angular restrictor fusion spliced into the fiber arrangement before the sensing fiber at the opposing end from the laser. The sensing fiber, laser and photodetector are fusion spliced together with an optical coupler, which increases build costs and adds unnecessary complexity to the sensing system. This configuration introduces losses in optical power from the various fiber connections as well as the intrinsic losses in the numerous optical components. Tapanes does not teach putting in light communication the laser and photodetector by locating multi-mode optical fibers (having at least one going to the photodetector and at least one coming from the laser) in side by side butt orientation with one end of the sensing fiber having the other end of the sensing fiber roughly terminated without an added reflector. Tapanes single ended embodiment requires multiple fusion splices using single-mode fibers, couplers, splitters, reflectors etc. thus increasing expense and reducing system reliability.

Another prior art example of a single photodetector modal-domain optical fiber sensor system for vibration monitoring is taught in U.S. Pat. No. 4,854,706 by Claus that comprises a laser that injects coherent light into one end of a multimode optical fiber, with the other end of the fiber attached to the device to be monitored, having at the end opposing the laser, a spatial filter and a photodetector. The photodetector input is limited by the spatial filter, thereby allowing the photodetector to ‘view’ a portion of the speckle or multi-path interference pattern. Any shift, motion or disturbance to the sensing fiber causes the interference pattern within the fiber core to change causing the total power detected by the photodetector to change, Claus teaches that the laser light is launched into one end of the sensing fiber, and the spatial filter and photodetector receive the output from the sensing fiber at the opposing end from the laser, but fails to teach or imply the elimination of the spatial filter, or having all components on one end of the sensing optical fiber.

Despite the advantages taught in the prior art, the current optical sensor. systems available today require a higher component count with expensive, pigtailed optical fiber coupling and labor-intensive interconnection hardware. Much of the expense of integrating the components into a rugged modal-domain optical fiber sensor system package involves mechanical coupling methods, connectorizing, fusion splicing, etc. These methods are necessary to insure that all critical components stay connected, protected, aligned, and in good light communication with one another. Using combinations of single and multimode optical fibers having multiple fusion splices and/or mechanical interfaces, splice trays, pigtails and other, vulnerable fiber-optic interconnections decreases sensor reliability and increases manufacturing and component costs. Nothing in the prior art suggests or teaches a solution to the fading effect, which is a fundamental weakness to sensing the shifts and vibrations of the speckle pattern.

### SUMMARY OF THE INVENTION

The object of the present invention is to overcome the shortcomings in the prior art and provide a modal-domain optical fiber sensor systems for, but not limited to, mechanical vibration monitoring or physical motion detection. The invention includes a coherent light source (ie: a laser) that injects or launches a beam of light into one of the “I/O” ports of the Launch Optical Coupler (LOC). Light propagates down the sensing fiber while undergoing mechanically-induced multipath interference effects and returns from the terminated or reflective end of the sensing fiber to the LOC sensing fiber port. In practice, the sensing fiber is field terminated or cut to a desired length, and then secured to the device or area to be monitored which imparts disturbances to the sensing fiber. Speckle pattern light is received back from the sensing fiber and directed to a photodetector via the other I/O port of the LOC. Through spatial restriction that is mechanically built into the LOC, the geometric filtering is performed implicitly, and the varying light intensity level is monitored by the photodetector which correlates, both in magnitude and frequency, with the physical disturbance or event imparted to the sensing fiber. The varying power signal at the photodetector is passed on to application-specific gain and filtering electronics and then to a micro-computer system for deciphering, recording, and analysis of the frequency and amplitude characteristics of the disturbance.

The preferred embodiment of the LOC comprises a robust housing enclosing the ends of at least two multimode optical fibers: the first, an injection fiber (first I/O port) and second, a detection fiber (second I/O port). The injection and detection ports on the LOC can be symmetrical and interchangeable. Additional detection fibers can be added to provide input into a discrete detection means involving the multiplexing of photodetectors to improve sensitivity, while reducing the negative effects of signal fading (fading effect), which is common among single detector modal-domain optical fiber sensor systems. Moreover, additional injection fibers can provide redundancy with different laser injection sources enabling further utility in differing applications. For this application for patent, the singular of a multimode optical fiber does not limit interpretation to only one, as the plurality options of multiple components are disclosed herein, as secured by one LOC.

The LOC housing having a first end and second end is constructed and arranged to receive the multimode sensing fiber connection at the first end, and the injection and detection fibers at the second input/output end. The LOC provides the construct for the securing of the sensing fiber in butt opposition to the injection fiber and detection fiber. The sensing fiber is connected via standard barrel or ferrule connection to the first end of the LOC, however integration via resin or mechanical pinch to make the connection permanent is also an option.

The injection fiber is positioned within the second end of the LOC (first I/O port) such that the injection fiber imparts coherent light from the laser into the end of the sensing fiber connection. The injection fiber is a multimode fiber that has a relatively small diameter when compared to the sensing fiber, and is in light communication on one end with the coherent light source, with the other end secured within the LOC's second end, and located to impart coherent light into the sensing fiber.

The detection fiber is positioned within the second end of the LOC (second I/O port) along side of the injection fiber, and geometrically restricts and receives coherent light emitting from the sensing fiber, and passing through the same to the photodetector. For the preferred embodiment a 4:1 ratio is utilized as the sensing fiber has a core diameter of 200 um, and the detection fiber has a 50 um diameter. The difference in diameters between the sensing fiber and the detection fiber cores, as located in relation to one another provides the desired geometric filtering or restriction (spatial and/or angular) prior to the light being passed to the photodetector. The geometrical restriction may either be spatial, angular, or both. The detection fiber as secured within the LOC geometrically filters the light, enabling the photodetector to sense the disturbance in the sensing fiber.

In all embodiments of the subject invention, a critical and unique feature is the LOC, and its light communication connection between the sensing fiber, laser, and photodetector. The LOC eliminates the need for explicit spatial filters, single-mode optical fibers, complicated cleaving and termination methods, or expensive communication-grade, connection means. Besides the simple, robust construction and compact form-factor benefits of the LOC, the laser injection and detection multimode optical fibers are insensitive to disturbance. This means that the LOC can now be physically located near the vibration or disturbance while allowing the laser drive and detection electronics to be remotely located and optionally isolated without suffering a performance penalty.

The insensitive lead-in feature and the single-ended sensing fiber configuration makes for a reliable, easy to deploy sensor system, rugged enough to be deployed in the most hostile environmental conditions.

A computer system or other interpretation device(s) receives the input from the photodetector and then deciphers, records, and/or provides monitoring means of the disturbance. The method and processes used in deciphering, recording, and monitoring the disturbance are well known in the art, and include but are not limited to the inclusion of a logarithmic amplifier, a transimpedance amplifier with fixed gain connected to the photo diode, noise-reduction filters, gain blocks and bandpass filters before the signal is converted to a digital data stream or an analog voltage/current loop output.

### OBJECTS AND ADVANTAGES

It is a primary object of the present invention to provide an improved modal domain optical fiber sensor (hereinafter sensor) capable of monitoring or detecting vibrations using a sensing fiber terminated on one end, and connected at the other end by light communication means uses only multimode optical fiber for the light communication between the laser, photodetector, and sensing optic fiber.

An object of the present invention is to provide an improved sensor that works effectively over a very wide range of optical power and low reflective characteristics at the terminated end of the sensing fiber.

It is another object of the present invention to provide an improved sensor that can be configured to utilize more than one detection fiber, each providing input to a photodetector thereby reducing or eliminating the undesirable ‘fading’ effect that commonly plagues the performance of modal-domain sensors.

It is still another object of the present invention to provide an improved sensor that does not require an explicit spatial filter in line and before the photodetector.

It is still yet another object of the present invention to provide an improved sensor that benefits from an optical coupler and reducer that mechanically interconnects the laser and photodetector with a commercial, standard type barrel or ferrule connector providing removable engagement of the sensing fiber.

It is another object of the present invention to provide an improved sensor that can be configured to utilize more than one injection fiber and more than one detection fiber as coupled to a single sensing fiber to improve reliability while enhancing amplitude and frequency sensing.

Another objective of the present invention is to provide a means of launching light and receiving light from a multimode sensing fiber that does not require the far end of the sensing fiber to be connected or coupled to anything. The far end of the sensing fiber can have a simple cleave (4% glass-to-air reflection), or a sputtered-on or plated reflector, and at a minimum, a crude cut yielding a reflection far less than required on prior art configurations.

A final object of the present invention is to provide an improved sensor that benefits from the improved method of implementing the sensing fiber, the laser, and the photodetector, all in simultaneous light communication within a single LOC, without the need of an explicit spatial filter in front of and before the photo diode, using only multimode optical fibers, eliminating the need for any single-mode optical fiber.

These and other objects and advantages will become apparent when viewed in light of the following description and appended drawings

### BRIEF DESCRIPTION OF THE DRAWINGS

FIG. 1—Diagrammatic representation of the LOC as integrated within a modal domain optical fiber sensor system.

FIG. 2—Perspective rendering of the injection fiber, detection fiber, and sensing fiber as they are positioned to one another within the LOC.

FIG. 3—Diagrammatic representation of the preferred embodiment showing advantage achieved without mirror quality at terminated sensing fiber end.

### DETAILED DESCRIPTION OF THE PREFERRED EMBODIMENTS

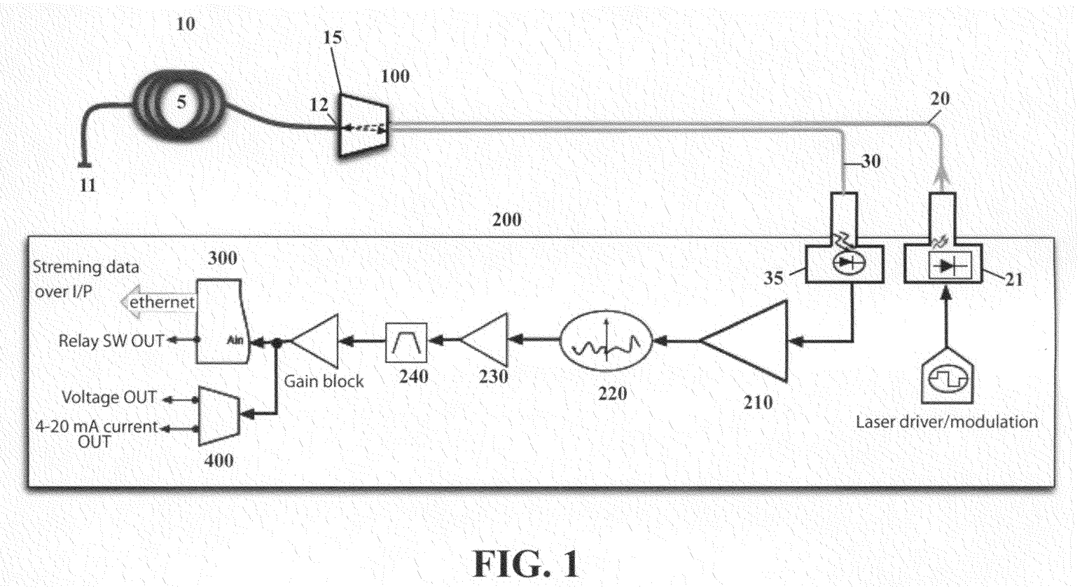

The present invention shown as a preferred embodiment in FIG. 1-3, relates to modal domain optical fiber sensor systems for mechanical vibration monitoring, or physical motion detection. The common prior art modal domain optical fiber sensor system had a laser 21 injecting light into a first end of the sensing multimode optical fiber (sensing fiber) 10, with a spatial filter at the opposing second end of the sensing fiber 10, followed by a photodetector 35. The sensing fiber 10 is then secured to the device or area to be monitored which imparts disturbances 5 to the sensing fiber 10, which are observed at the photodetector 35 by sensing the fractional changes as provided by the speckle-pattern. Applicants' invention eliminates the need for an added spatial filter, allows the injecting of coherent light and detecting of the speckle-pattern to be conducted from one end of the sensing fiber 10, and accomplishes the same using only multimode optical fiber having a roughly terminated end 11 with some reflection characteristics.

In the preferred embodiment shown in FIG. 1, Applicant's preferred detection means includes a logarithmic amplifier 210 for conditioning the signal from the photodetector 35, which allows for the terminated end 11 to be of minimal reflection characteristics, having successful sensing, with as little as 0.01% reflection at the terminated end 11. Other signal conditioning is performed by electronic components including the noise reduction filter 220, the gain block 230, the LP filter 240, with final output either in analog output 400 or digital output 300.

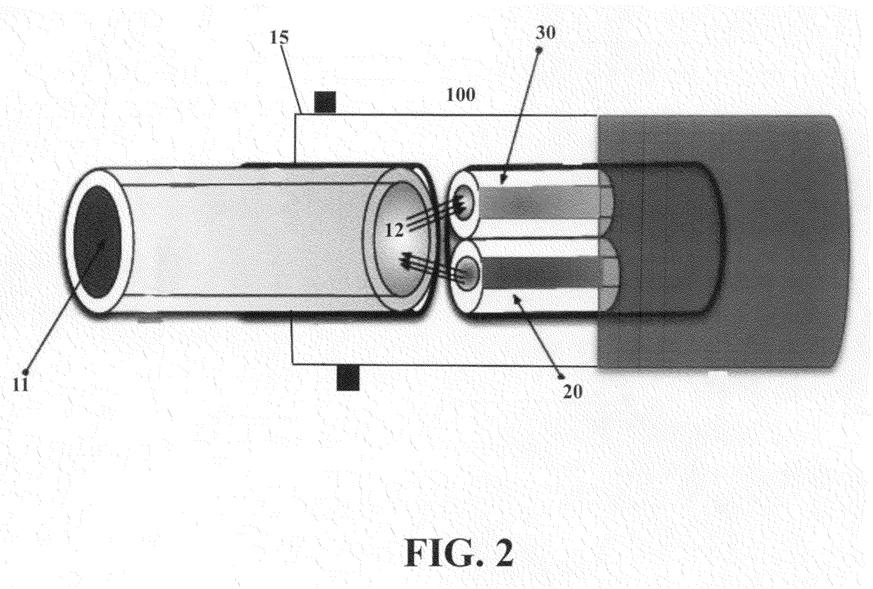

As shown in system of FIG. 1 and by specific location in FIG. 2, the LOC 100 secures an injection fiber 20 output that is in light communication with the laser 21 and secures a detection fiber 30 input that is in light communication with the photodetector 35, each approximately side by side as located within the LOC 100, and positioned such that the ends of the detection fiber 30 and injection fiber 20 approximately face the LOC sensor end 15 that receives the I/O end 12 of the sensing fiber 10. The exacting location of the side by side oriented detection fiber 30 and injection fiber 20 will vary perapplication, and with the number of additional fibers added. The LOC 100 provides the structure to secure the sensing fiber 10, the injection fiber 20, and the detection fiber 30, all being in light communication with one another.

The sensing fiber 10 has a terminated end 11 with minimal reflective properties and is cleaved to provide a flat butt end at the I/O end 12. Cleave for the purposes of this application means: a flat fiber cut end (for angular restriction an angle cut is beneficial rather than a straight flat cut) such that two similar fibers butted or fused together yield a minimal loss in optical power. When the sensing fiber 10 is engaged to the LOC sensor end 15, the laser 21 imparts through an injection fiber 20 a beam of coherent light into the I/O end 12 of the sensing fiber 10, which reflects in part back from the terminated end 11. The coherent light returning back to the I/O end 12 after reflecting from the terminated end 11 of the sensing fiber 10 projects as speckle-pattern light that is then geometrically filtered or restricted spatially at the LOC 100 by the detection fiber 30, and then directed into a photodetector 35.

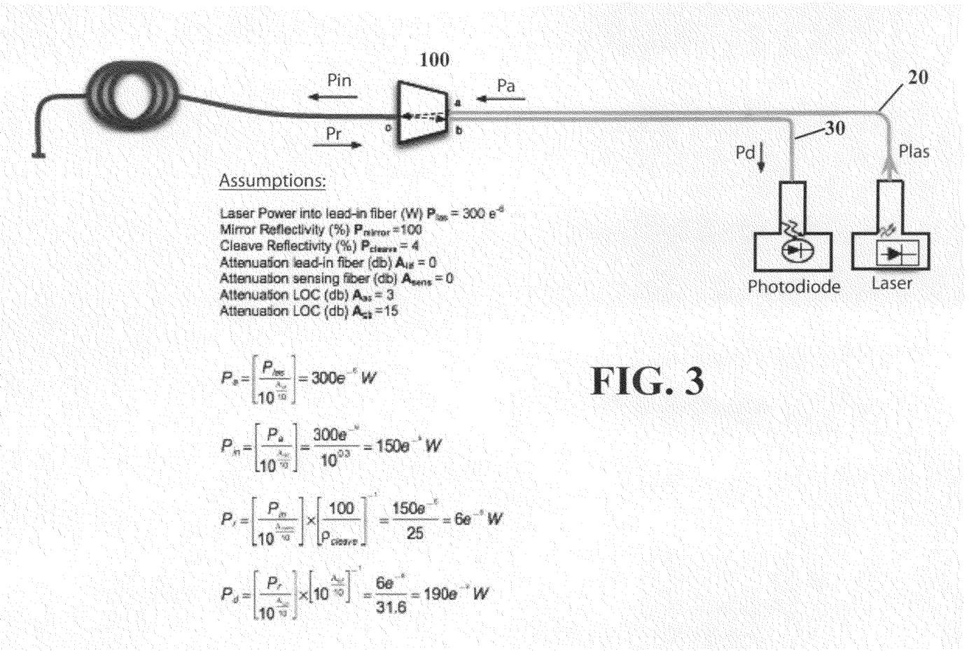

As described and shown in FIG. 3, the varying voltage and/or current produced by the photodetector 35 correlates with the disturbance 5 that causes the speckle pattern to shift and move at the I/O end 12 of the sensing fiber 10. The varying power signal at the photodetector 35 is passed to a computing system 200 for deciphering, recording, or monitoring of the frequency and amplitude characteristics of the disturbance. The detection means includes the photodetector 35 (photodiode) and computing system 200 working in concert to decipher the disturbance from the speckle-pattern. In the preferred embodiment, the computer system 200 that receives signal from the detector 35 includes a logarithmic amplifier 210 which significantly decreases the need for reflectivity (4% as shown in cleave reflectivity-Pcleave) at the terminated end 11 of the sensing fiber 10 as mathematically depicted in FIG. 3.

For the preferred embodiment shown in FIG. 3 with an assumed 4% cleave reflectivity, the logarithmic amplifier 210 used in the electronics connected to the output of the detector 35 provides a small signal result (fractional currents changes in the photodetector due to speckle pattern shifts) at it's output that is constant over many decades of optical power or resulting current. Since the losses in the sensor configuration outlined by the preferred embodiment of this invention are dependent on numerous factors, the logarithmic amplifier 210 compensates automatically by increasing and decreasing its small-signal AC gain such that the disturbance (fractional AC signal that is amplitude modulated on the larger mean light level) or vibration/disturbance picked up over the entire length of the sensing fiber remains independent of fiber and reflectivity losses. This means that a physical disturbance imparted to the sensing fiber near the LOC or near the terminated end of the sensing fiber will result in the same output signal, virtually unaffected by the reflection coefficient at the termination end (i.e. 99% or 0.01%) or loss due to the length of the sensing fiber.

As shown by the perspective rendering of FIG. 2, the preferred orientation of the detection fiber 30 and injection fiber 20 is side by side entering the LOC 100. The geometric filtering or spatial restriction is implicitly achieved as built into the LOC 100 interconnection by advantaging a relatively small diameter detection fiber 30 (e.g. 50 um) as receiving from a relatively large diameter sensing fiber (e.g 200 um). The geometric filtering is performed implicitly, in that the smaller diameter detection fiber 30 restricts the light received from the sensing fiber 10, before it reaches the photodetector 35, thereby negating the need for an explicit or added geometric filter.

As the preferred embodiment is shown in FIG. 1-3, the sensing fiber 10 is a 200 um step or graded index multimode fiber, and mechanically coupled or secured to a device or area to be sensed for disturbance or monitoring 5. The terminated end 11 requires only a simple cleave or cut resulting in a minimal reflection, and this is acceptable for most applications. A simple cleave (approx 4% reflection) or optical fiber cut can be made with a pair of snips or cutters for shorter sensing fiber lengths and a mirror reflector added or other reflective device connected when longer sensing fibers are required by the application. Being able to field tailor the sensing fiber's 10 length is a significant advantage over the prior art. With the logarithmic amplifier 210 included in the detection means, the required reflectivity is minimal, and can be as low as 0.01% for a 1 meter sensing fiber. This advantage of rough termination of the sensing fiber 10 is advantageous when doing a field installation and when the sensing fiber length needs to be trimmed quickly and easily without requiring special tools or skills to do so.

The I/O end 12 of the sensing fiber 10 is secured by the Launch Optical Coupler (LOC) 100 by commonly used barrel or ferrule-type connections that provide convenient and removable engagement of the sensing fiber 10 with the LOC 100, thereby allowing versatility in application, changes in installation, and easy replacement of the sensing fiber 10 when damaged or replaced.

The injection fiber 20 shown in FIG. 1-3 is a 50 um multimode optical fiber, and is insensitive to disturbance 5. The injection fiber 20 is in light communication on one end with a laser 21, and the other end secured by the LOC 100. The injection fiber 20 is located and positioned to impart coherent light from the laser 21 into the I/O end 12 of the sensing fiber 10. The laser 21 may be driven or pulsed depending on application. Also, the injection fiber 20 does not have to be in physical contact with the sensing fiber 10, and a distance or cavity with or without a lens may be used depending on application. The preferred embodiment uses a 50 um fiber, but in practice, any diameter size smaller than the sensing fiber 10 will suffice, depending on configuration and the number of fibers secured within the LOC 100. For example, a 62.5 um injection fiber 20 is commonly available, relatively inexpensive, and would work well with a 200 um sensing fiber 10.

The detection fiber 30 shown in FIG. 1-3 is a 50 um multimode optical fiber, and is insensitive to disturbance 5. The detection fiber 30 is in light communication on one end with a photodetector 35, and the other end is secured by the LOC 100 and in light communication with the I/O end 12 of the sensing fiber 10. The detection fiber 30, being relatively small in diameter when compared to the sensing fiber 10 (50 um compared to 200 um), receives only a portion of the light emitting from the sensing fiber 10. The geometric filtering for the preferred embodiment as shown is accomplished spatially and ratiometrically with a 4:1 core diameter ratio and angularly with differing numerical apertures (NA) as between the detection fiber 20 (50 um) and the sensing fiber 10 (200 um). Geometric filtering may also be accomplished through angular placement of the sensing fiber 10 in relation to the detection fiber 30, or performed by other core/NA ratios between the sensing fiber 10 and detection fiber 30.

The LOC 100 is not limited to locating just one detection fiber 30, and due to the robust design of the system, a plurality of detection fibers 30 may be located to receive the speckle pattern light imparting from the sensing fiber 110. Having more than one detection fiber 30 outputting into a discrete detection means, the undesirable fading effect is reduced. What is meant by discrete detection means is when each detection fiber 30 provides geometrically filtered speckle pattern light to a single photodetector multiplexed with other receiving photodetectors.

The laser 21 shown in FIG. 1-3 may be pulsed or modulated to increase efficiency and/or create chaos in the optical spectrum output of the laser to reduce audio-frequency coherence noise in the sensor. Any coherent light source will work, and the preferred embodiment utilized a VSCEL laser having power output of 300 uW and a wavelength 850 nm. Many different varieties and brands of photodetectors 35 that are currently available can work well in the application as illustrated in FIG. 1. A silicon PIN photo diode was used in the preferred embodiment with success.

Securing methods for the injection fiber 20 and detection fibers 30 within the LOC 15 housing include, but are not limited to, precision machining, polymer potting materials, glues, and resins. The housing may be of any material suitable to the requirements, as metal alloy is a first choice for barrel or ferrule type connection of the sensing fiber 10.

The LOC 100 shown in FIG. 1-3 only has one injection fiber 20 and one detection fiber 30, which for most applications performs satisfactorily. For special applications, where additional sensitivity is needed, or where the ‘fade’ of the speckle pattern poses a problem, additional detection fiber 30 may be added to multiplex more than one photodetector 35. Advantages of having more than one injection fiber 20 are apparent to reduce the ‘fade’ effect of the speckle pattern. Redundant laser 21 systems can be included to increase the reliability in certain hostile environments by adding additional injection optic fibers.

Modifications within the spirit and scope of the invention may become apparent to one of skill in this art, and it is to be understood that this invention is not limited to the particular embodiments, features, and examples described herein.

What is claimed is:

1. A modal domain fiber optic sensor for detecting disturbance comprising:
a multimode sensing fiber that is reflectively terminated on one end;
at least one injection fiber output from a coherent source means;
at least one detection fiber input to a detection means;
a coupler having a first end and a second end;
the first coupler end constructed to receive at least one injection fiber and at least one detection fiber;
the injection fibers and detection fibers being located side by side within the first coupler end;
the second coupler end constructed to receive the non-terminated end of the sensing fiber;
the coupler constructed and arranged to locate each injection fiber to impart light into the sensing fiber and locate each detection fiber to receive a restricted portion of the speckle-patterned light projecting from the sensing fiber's non-terminated end; and
the detection means providing an output representative of the disturbance impacting the sensing fiber.

2. A modal domain fiber optic sensor for detecting disturbance comprising:
a multimode sensing fiber that is reflectively terminated on one end;
at least one injection fiber output from a coherent source means;
more than one detection fiber, each inputting to a discrete detection means;
a coupler having a first end and a second end;
the first coupler end constructed to receive at least one injection fiber and more than one detection fiber;
the injection fibers and detection fibers being secured side by side within the first coupler end;
the second coupler end constructed to receive the non-terminated end of the sensing fiber;
the coupler constructed and arranged to locate each injection fiber to impart light into the sensing fiber and locate each detection fiber to receive a restricted portion of the speckle-patterned light projecting from the sensing fiber's non-terminated end; and
the discrete detection means having each detection fiber inputting into a separate photodetector providing an output representative of the disturbance impacting the sensing fiber.

3. An improved fiber-optic sensing method utilizing modal interference in a multimode sensing fiber, of the type having an injection fiber output from a coherent source means injecting light into the sensing fiber on one end, that projects a multimode speckle pattern out the other end, and through a geometric filter that passes a portion of the speckle pattern light into a detection fiber that directs the same into a detection means for measuring the intensity of said light and providing an output representative of the disturbance being sensed at the sensing fiber, the improvement comprising:
securing at least one injection fiber and at least one detection fiber in light communication with a first end of the sensing fiber;
terminating a second end of the sensing fiber so that the terminated end has reflective characteristics; and
geometrically filtering the speckle-pattern light with the detection fibers' diameter, angular position, or physical location in relation to the sensing fiber's non-terminated end.

4. A modal domain fiber optic sensor of claims 1, 2 and 3, wherein the detection fibers are constructed of multimode optic fiber.

5. A modal domain fiber optic sensor of claims 1, 2, and 3, wherein the injection fibers are constructed of multimode optic fiber.

6. A modal domain fiber optic sensor of claims 1, 2, and 3, wherein the sensing fiber is 200 um in core diameter, and the injection fibers are no larger than 62.5 um in core diameter.

7. A modal domain fiber optic sensor of claims 1, 2, and 3, wherein the sensing fiber is 200 um in core diameter, and the detection fibers are no larger than 62.5 um in core diameter.

8. A modal domain fiber optic sensor of claims 1, 2, and 3, wherein the sensing fiber core diameter is between 62 um to 1 mm.

9. A modal domain fiber optic sensor of claims 1, 2, and 3, wherein the sensing fiber's terminated end has a reflection coefficient of 0.1% to 4%.
